(19) United States
(12) Patent Application Publication
(10) Pub. No.: US 2005/0050485 A1
(43) Pub. Date: Mar. 3, 2005

(54) Systems and methods for identifying data sources associated with a circuit design

(76) Inventors: S. Brandon Keller, Evans, CO (US); Gregory Dennis Rogers, Fort Collins, CO (US); George Harold Robbert, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/647,607

(22) Filed: Aug. 25, 2003

(51) Int. Cl. G06F 17/50

(52) U.S. Cl. 716/4

(57) ABSTRACT

Systems, methods, software products identify a data source used in analysis of a circuit design. Data source information, including identification of the data source used to generate data for an entity in a design portion of interest in the circuit design, is retrieved. The data source information is formatted as a bit vector associated with the entity, wherein each of a plurality of bits in the bit vector comprises indicia applicable to the entity. The bit vector is processed to generate formatted output.

### RELATED APPLICATIONS

The present document contains material related to the material of copending, cofiled, U.S. patent applications Ser. No. ______ Attorney Docket Number 100111221-1, entitled System And Method For Determining Wire Capacitance For A VLSI Circuit; Ser. No. ______ Attorney Docket Number 100111227-1, entitled System And Method For Determining Applicable Configuration Information For Use In Analysis Of A Computer Aided Design; Ser. No. ______ Attorney Docket Number 100111228-1, entitled Systems And Methods Utilizing Fast Analysis Information During Detailed Analysis Of A Circuit Design; Ser. No. ______ Attorney Docket Number 100111230-1, entitled Systems And Methods For Determining Activity Factors Of A Circuit Design; Ser. No. ______ Attorney Docket Number 100111232-1, entitled System And Method For Determining A Highest Level Signal Name In A Hierarchical VLSI Design; Ser. No. ______ Attorney Docket Number 100111233-1, entitled System And Method For Determining Connectivity Of Nets In A Hierarchical Circuit Design; Ser. No. ______ Attorney Docket Number 100111234-1, entitled System And Method Analyzing Design Elements In Computer Aided Design Tools; Ser. No. ______ Attorney Docket Number 100111235-1, entitled System And Method For Determining Unmatched Design Elements In A Computer-Automated Design; Ser. No. ______ Attorney Docket Number 100111236-1, entitled Computer Aided Design Systems And Methods With Reduced Memory Utilization; Ser. No. ______ Attorney Docket Number 100111238-1, entitled System And Method For Iteratively Traversing A Hierarchical Circuit Design; Ser. No. ______ Attorney Docket Number 100111257-1, entitled Systems And Methods For Establishing Data Model Consistency Of Computer Aided Design Tools; and Ser. No. ______ Attorney Docket Number 100111260-1, entitled Systems And Methods For Performing Circuit Analysis On A Circuit Design, the disclosures of which are hereby incorporated herein by reference.

### BACKGROUND

An electronic computer aided design (“E-CAD”) tool is used to create and analyze a circuit design, including a very large scale integration (“VLSI”) circuit design. The circuit design consists of a “netlist,” which identifies electronic design elements (e.g., capacitors, transistors, resistors, etc.), and the interconnectivity (“nets”) of design elements. The circuit design is constructed from hierarchical design blocks (also known as cells) that provide specific functionality to the circuit design. These design blocks may be re-used within the circuit design, or within other circuit designs. Design blocks may be constructed from design elements, nets and other design blocks, and may be used one or more times in the circuit design.

During analysis of the circuit design, the E-CAD tool operates on more than one type of data source, such as estimated data, data extracted from art work, and data input by a user. By operating on more than one type of data source, the E-CAD tool is capable of analyzing design blocks that are not yet complete.

Each “net” is a single electrical path in a circuit that has the same logical value (e.g., electrical characteristic) at all of its points. Any collection of wires that carries the same signal between design elements is a net. If the design elements allow the signal to pass through unaltered (as in the case of a terminal), then the net continues on subsequently connected wires. If, however, the component modifies the signal (as in the case of a transistor or a logic gate), then the net terminates at that component and a new net begins on the other side.

A significant characteristic of VLSI and other types of circuit design is a heavy reliance on hierarchical description. A primary reason for using hierarchical description is to hide the vast amount of detail in a design. By reducing the distracting detail to a single object that is lower in the hierarchy, many computer aided design (“CAD”) operations are greatly simplify. For example, simulation, verification, design-rule checking, and layout constraints can all benefit from hierarchical representation, which makes them much more computationally tractable. Since many circuits are too complicated to be easily considered in their totality, a complete design is often viewed as a collection of component aggregates that are further divided into sub-aggregates in a recursive and hierarchical manner. In VLSI circuit design, these aggregates are commonly referred to as ‘blocks’ (or ‘cells’); the use of a block at a given level of hierarchy is called an ‘instance’. A net within one block may connect with a net in another block, the net ‘pieces’ forming a single net known as a ‘highest level signal name’ (“HLSN”). An HLSN is identified by the name of the net ‘piece’ located at the highest hierarchical level in the circuit design.

The E-CAD tool typically generates a human readable report containing analysis results. In the report, entire result messages are included for each data source. For other analysis tools to utilize information in the report, complex parsing algorithms are required. Accordingly, the other analysis tools also require substantial user intervention to determine data sources associated with the circuit design, reducing the effectiveness of the other analysis tools and slowing analysis of the circuit design.

### SUMMARY

In one embodiment, a method identifies a data source used in analysis of a circuit design. Data source information, including identification of the data source used to generate data for an entity in a design portion of interest in the circuit design, is retrieved. The data source information is formatted as a bit vector associated with the entity, wherein each of a plurality of bits in the bit vector comprises indicia applicable to the entity. The bit vector is processed to generate formatted output.

In another embodiment, a system identifies a data source used by a CAD tool in analysis of a circuit design, wherein a plurality of data sources are available to the CAD tool. A processor is coupled to a computer memory. A plurality of data source indicators is stored in the computer memory; each of the indicators comprising a plurality of bits for identifying the data sources associated with an entity in a design portion of interest in the circuit design. A table is stored in the computer memory, formatting the data source indicators.

In another embodiment, a system identifies data sources associated with a circuit design, and includes: means for retrieving data source information that identifies at least one of the data sources; means for formatting the data source information as a bit vector, wherein each of a plurality of bits in the bit vector comprises indicia of a specific data source applicable to an entity in a design portion of interest in the circuit design; and means for processing the bit vector to generate formatted output.

In another embodiment, a software product comprising instructions, stored on computer-readable media, wherein the instructions, when executed by a computer, perform steps for identifying data sources used in analysis of a circuit design, including: instructions for retrieving data source information that identifies a data source; instructions for formatting the data source information as a bit vector, wherein each of a plurality of bits in the bit vector comprises indicia of the data source applicable to an entity in a design portion of interest in the circuit design; and instructions for processing the bit vector to generate formatted output.

### BRIEF DESCRIPTION OF THE DRAWINGS

FIG. 1 shows an exemplary embodiment of an E-CAD system for identifying data sources associated with a circuit design.

FIG. 2 is a flowchart illustrating exemplary steps performed in operation of the system of FIG. 1.

FIG. 3 is a flowchart illustrating one method for identifying data sources associated with a circuit design.

### DETAILED DESCRIPTION

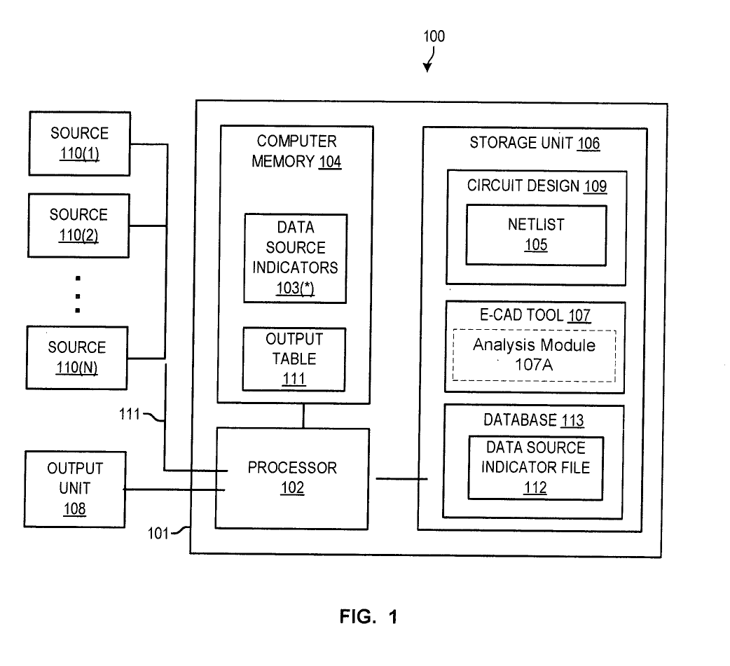

FIG. 1 shows one system 100 configured for identifying data sources associated with an electronic circuit design, e.g., circuit design 109. System 100 is particularly useful in identifying data sources for use by an electronic computer aided design (“E-CAD”) tool (e.g., E-CAD tool 107) during analysis of circuit design 109. System 100 includes a computer system 101, which controls E-CAD tool 107 to analyze circuit design 109, typically by also processing a netlist 105 of circuit design 109.

Computer system 101 includes processor 102 that is coupled to computer memory 104 and a storage unit 106. In one embodiment, E-CAD tool 107 initially resides in storage unit 106. Upon initialization, E-CAD tool 107 and at least part of circuit design 109 is loaded into computer memory 104. During operation of system 100, an analysis module 107A of E-CAD tool 107 is executed by processor 102 to receive data source information that identifies the source of data associated with an entity of circuit design 109. An “entity” is for example any part of circuit design 109, such as a design element, group of design elements, HLSN, net, net piece, cell, and block; and entity may also be a group of such entities. Analysis module 107A generates a data source indicator 103 from the data source information and formats data source indicator 103 to generate output (described below) indicating the source of the design elements.

Illustratively, processor 102 couples to data sources 110(1), 110(2) . . . 110(N) [hereinafter referred to as data sources 110(*)] so that analysis module 107A in E-CAD tool 107 retrieves information from data sources 110(*) as a net is traced through design 109. Data sources 110(*) may include, for example, user input, design analyzers, computer aided design (“CAD”) tool data estimators, and the like. In one example, source 110(1) represents user input (e.g., via a keyboard) that provides a data value of a first design element, while source 110(2) represents a CAD tool estimator that provides a data value of a second design element; source 110(N) may for example provide a data value of a third design element of design 109 as determined by a CAD analysis tool analyzing the third design element. E-CAD tool 107 accordingly identifies data sources used in an analysis such that complex parsing algorithms and redundant message displays are not needed. The source of the data for each entity of interest in design 109 is stored with design element data and remains available after E-CAD tool 107 completes analysis of design 109.

By way of illustrative example, design elements of a VLSI circuit design are analyzed by an analysis tool (e.g., a CAD tool estimator, design analyzer) to generate data values (e.g., capacitance, resistance, leakage current) for data sources 110(*). Each of data sources 110(*) generates a value for a characteristic (e.g., wire capacitance) of a particular design element in design 109. In an exemplary embodiment, each design element in design 109 has associated therewith a data source indicator 103(*), where the ‘*’ character indicates the specific data entity or group of data entities to which the indicator applies, such as a net, an HLSN, a design element, or a particular design block or cell. Data source indicators 103(*) indicate the source of the data for the associated entity, for example, one source is an E-CAD tool functioning as a capacitance estimator source. Output unit 108 is coupled to processor 102 for displaying one or more of data source indicators 103(*). Examples of output unit 108 include a printer, a data storage device, and a display, such as a computer monitor. In one embodiment, E-CAD tool 107 and analysis module 107A are operable to generate data at output unit 108 to identify data sources 110 associated with design 109.

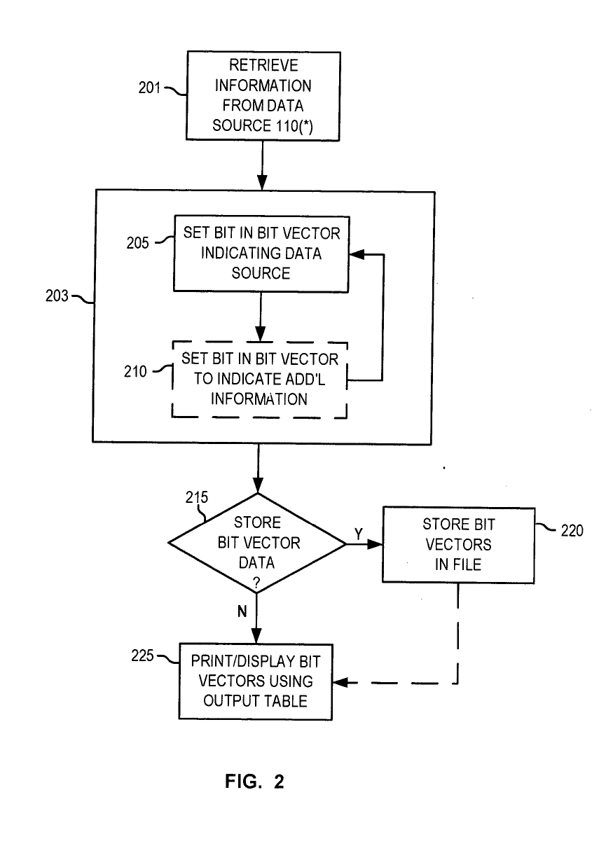

FIG. 2 is a flowchart illustrating exemplary steps performed in operation of system 100, FIG. 1. Operation of the present system is best understood by viewing FIG. 1 and FIG. 2 in conjunction with one another. As shown in FIG. 1 and FIG. 2, in step 201, information is retrieved from one or more data sources 110(1), 110(2) . . . 110(N), as E-CAD tool 107 (or analysis module 107A within E-CAD tool 107) traces a list of component nets of an HLSN in design 109. As E-CAD tool 107 traces the hierarchy of the design elements in design 109, it processes data for nets (or net pieces) connected to each HLSN of interest in design 109. In step 203, as each net is encountered, a data source indicator 103(*) associated with each HLSN is updated to indicate the source of the data 110(*) for that HLSN, in step 205. Alternatively, data source indicator 103(*) may be updated to indicate the data source 110(*) for a specific net, a particular block, or for any design element or group of design elements in design 109. In addition to step 205, in an alternative embodiment (described below), step 210 may also be performed to allow additional information to be stored in data source indicator 103(*).

In one embodiment, each data source indicator 103(*) is a ‘bit vector’ in which, for example, each bit in the vector indicates the source 110(*) of the data used for, or applicable to, one or more entities of interest in design 109. Combinations of bits within a data source indicator 103(*) may be used as indicia to represent one or more data sources or to represent additional information, such as the type of analysis performed, limits that were applied to numeric quantities, or errors that occurred while processing the design element. For example, as E-CAD tool 107 traces through a hierarchical circuit netlist to combine data values, some of the data may originate from an estimation of the data, some of the data may originate from an artwork extraction of the design, and/or some of the data may originate from user input or other sources.

When analysis of an HLSN, block, or other portion of design 109 is complete, a determination is made in step 215 as to whether data source indicators 103(*) are to be saved for later use by another analysis tool. If data source indicators 103(*) are not to be saved, then data source indicators 103(*) may be printed or otherwise displayed, as described below in step 225. If data source indicators 103(*) are to be saved, then in step 220, data source indicators 103(*) are stored in a file (e.g., as output by analysis module 107A). In one example, E-CAD tool 107 may store data source indicators 103(*) in a file in output unit 108, or save them to a data source indicator file 112 in storage unit 106, where data source indicators 103(*) are stored along with the analysis result information in a database 113. In either event, data source indicators 103(*) are relatively compact in comparison to text messages, and thus provide a comparative reduction in the amount of computer or other memory used for data source indicator storage. Alternatively, a ‘decoded’, or formatted version of each data source indicator 103(*) may be stored in data source indicator file 112 or in a separate database, as well.

In step 225 (which is optional if data source indicators 103(*) were stored in a file in step 220), table-driven methodology assists in printing or otherwise displaying data source indicators 103(*) and associated data. In an exemplary embodiment, each data source indicator 103(*) is stored in an output table 111 (e.g., within computer memory 104) in a format that indicates the meaning of each bit in the vector. Output table 111 is used to format data source indicators 103(*) as meaningful characters, via output unit 108. In one embodiment, exemplary bit values (‘BitValues’) enumerated in Table 1 (below) may be used to decode bits of data source indicators 103(*) into printable messages.

An example of possible bit values that may be set in data source indicators 103(*) is shown below in Table 1:

TABLE 1

| enumerated BitValues { | |
|---|---|
| User | = 0×01, //= 00000001 |
| Artwork | = 0×02, //= 00000010 |
| Estimated | = 0×04, //= 00000100 |
| Default | = 0×08, //= 00001000 |
| Propagated | = 0×10, //= 00010000 |
| MASK | = 0×1F, //= 00011111 |
| }; | |

An example of an associated output table 111 for formatting data source indicator output is set forth below:

OUTPUT TABLE 111
static const BitVectorDef af_printdef[ ] = {

| | | | |
|---|---|---|---|
| //value | mask | set | clear |
| {BitVecAf::USER, | BitVecAf::MASK, | ″u″, | “—”}, |
| {BitVecAf::ARTWORK, | BitVecAf::MASK, | ″a″, | “—”}, |
| {BitVecAf::ESTIMATED, | BitVecAf::MASK, | ″e″, | “—”}, |
| {BitVecAf::DEFAULT, | BitVecAf::MASK, | ″d″, | “—”}, |
| {BitVecAf::PROPAGATED, | BitVecAf::MASK, | ″s″, | “—”}, |
| {0, | BitVecAf::MASK, | ″—″, | NULL}, |
| {0, | 0, | NULL, | NULL}, |
| }; | | | |

As an example, assume that a data source indicator 103(HLS1), representing data for an HLSN named ‘HLS1’ in design 109, has a binary value of 00001010. Assume, also, that the data associated with ‘HLS1’ has a value of 0.75. In this example, it can be seen, from the enumerated bit values shown above in Table 1, that the data for HLSN ‘HLS1’ was acquired from both artwork and default sources. After being formatted by processor 102 according to the above output table 111, the result would appear in an output file or printed/displayed message as:
0.75−a−d

In this example, the numeric value for the data is 0.75, and the alphabetic characters “a” and “d” indicate that the associated data was from ‘artwork’ and ‘default’ sources, in accordance with the formatting shown in output table 111.

In an alternative embodiment, in step 210, processor 102 may ‘overload’ data source indicators 103(*) to produce, for example, an analysis identifier that, in addition to providing the data source for an entity, also provides the type of analysis performed, or which provides other additional information, such as limits that were applied to numeric quantities, or errors that occurred while processing the design element.

Combinations of several bits in a data source indicator 103(*) may also be ‘overloaded’ to represent a single specific source. When a data source indicator 103(*) is overloaded, an ‘overlapping’ combination of bits (i.e., one in which a particular bit may have more than one significance, depending on its usage in combination with other bits, as well as the usage context) is used to indicate a second type of data source that cannot occur (or which is inapplicable) at the same time as the usage of a first data source. The first and second data sources are thus mutually exclusive, and therefore the use of bits that overlap with respect to two data sources is unambiguous in a particular context. The bits in a data source indicator may be overloaded such that a particular combination of bits represents more than two data sources, where the specific applicable source is dependent on the context in which the data source indicator is used. The significance of a particular pattern of overloaded bits may be interpreted by the use of two (or more) ‘masks’ to select from the appropriate regions of data source indicators 103(*), in order to facilitate formatting.

In one embodiment, processor 102 runs a script to decode data source indicators 103(*) associated with certain trends and/or quality assessments of the analysis. For example, one trend may indicate a user specified value, a CAD tool estimate, or a design extraction originating from one or more of data sources 110(*). Data source indicators 103(*) may be decoded using the script to provide trends, quality estimates, and/or assumptions of the analysis available for subsequent review.

Instructions that perform the operation shown in FIG. 2 may be stored on computer-readable storage media. These instructions may be retrieved and executed by a processor, such as processor 102 of FIG. 1, to direct the processor to operate in accordance with the present system. The instructions may also be stored in firmware. Examples of storage media include memory devices, tapes, disks, integrated circuits, and servers.

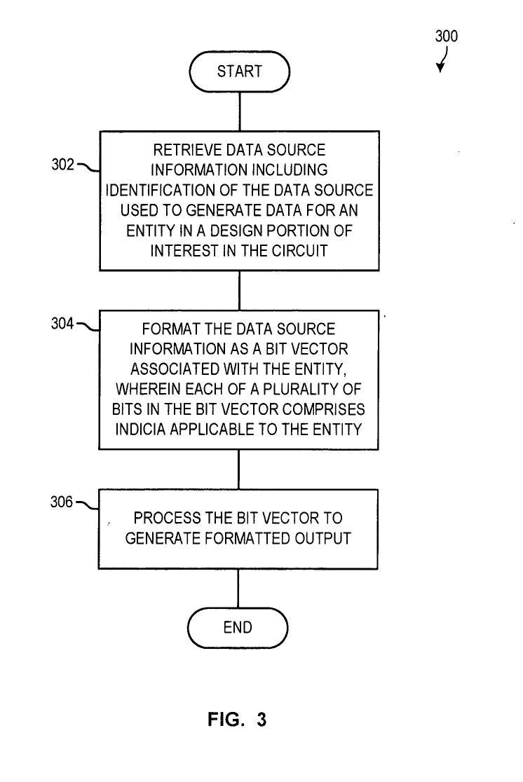

FIG. 3 is a flowchart illustrating one process 300 for identifying data sources associated with a circuit design. In step 302, data source information, including identification of the data source used, is retrieved to generate data for an entity in a design portion of interest in the circuit. In step 304, the data source information is formatted as a bit vector associated with the entity, wherein each of a plurality of bits in the bit vector comprises indicia applicable to the entity. In step 306, the bit vector is processed to generate formatted output.

Certain changes may be made in the above methods and systems without departing from the scope of the present system. It is to be noted that all matter contained in the above description or shown in the accompanying drawings is to be interpreted as illustrative and not in a limiting sense. For example, the items shown in FIG. 1 may be constructed, connected, arranged, and/or combined in other configurations, and the set of steps illustrated in FIG. 2 may be performed in a different order than shown without departing from the spirit hereof.

1. A method for identifying data sources associated with a circuit design, comprising:
retrieving data source information including identification of a data source used to generate data for an entity in a design portion of interest in the circuit design;
formatting the data source information as a bit vector associated with the entity, wherein each of a plurality of bits in the bit vector comprises indicia applicable to the entity; and
processing the bit vector to generate formatted output.

2. The method of claim 1, wherein the entity is at least one design element in the design portion of interest.

3. The method of claim 1, wherein the entity is a group of design elements in the design portion of interest.

4. The method of claim 1, wherein the entity is an HLSN in the design portion of interest.

5. The method of claim 1, wherein the entity is a net in the design portion of interest.

6. The method of claim 1, wherein the indicia includes information that identifies at least one specific data source applicable to the entity.

7. The method of claim 1, wherein the step of retrieving further includes retrieving information that identifies a type of analysis performed by the CAD tool, and wherein the indicia identifies a specific type of the analysis.

8. The method of claim 1, wherein the step of retrieving includes retrieving data source information that identifies limits that were applied to numeric quantities in the analysis, and wherein the indicia identifies the limits.

9. The method of claim 1, wherein the step of retrieving includes retrieving data source information that identifies errors that occurred while processing a design element, and wherein the indicia identifies the errors.

10. The method of claim 1, further comprising displaying the bit vector.

11. The method of claim 1, further comprising storing the bit vector in a file.

12. The method of claim 1, wherein the bit vector is overloaded such that a specific subset of a plurality of bits therein has a significance dependent on the specific subset and on usage context of the bit vector.

13. The method of claim 1, wherein the indicia identifies a specific type of the analysis.

14. The method of claim 1, wherein the indicia identifies limits that were applied to numeric quantities in the analysis.

15. The method of claim 1, wherein the indicia identifies errors that occurred while processing a design element in the design portion of interest.

16. A system for identifying a data source used by a CAD tool in analysis of a circuit design, wherein a plurality of data sources are available to the CAD tool, comprising:
a processor coupled to a computer memory;
a plurality of data source indicators, stored in the computer memory, each of which comprises a plurality of bits for identifying the data sources associated with an entity in a design portion of interest in the circuit design; and
a table, stored in the computer memory, for formatting the data source indicators.

17. The system of claim 16, wherein the data source indicators are generated from information retrieved from the data sources.

18. The system of claim 16, wherein a plurality of the bit vectors are processed by the processor to generate formatted output.

19. A system for identifying data sources associated with a circuit design, comprising:
means for retrieving data source information that identifies at least one of the data sources;
means for formatting the data source information as a bit vector, wherein each of a plurality of bits in the bit vector comprises indicia of a specific data source applicable to an entity in a design portion of interest in the circuit design; and
means for processing the bit vector to generate formatted output.

20. A software product comprising instructions, stored on computer-readable media, wherein the instructions, when executed by a computer, perform steps for identifying data sources used in analysis of a circuit design, comprising:
instructions for retrieving data source information that identifies a data source;
instructions for formatting the data source information as a bit vector, wherein each of a plurality of bits in the bit vector comprises indicia of the data source applicable to an entity in a design portion of interest in the circuit design; and
instructions for processing the bit vector to generate formatted output.
